(19) United States
(12) Patent Application Publication
(10) Pub. No.: US 2022/0263082 A1
(43) Pub. Date: Aug. 18, 2022

(54) SILICON ANODE BATTERY

(71) Applicant: ionobell, Inc., San Jose, CA (US)

(72) Inventors: Robert C. Ionescu, San Jose, CA (US); Chueh Liu, San Jose, CA (US)

(21) Appl. No.: 17/672,532

(22) Filed: Feb. 15, 2022

Related U.S. Application Data
(60) Provisional application No. 63/150,880, filed on Feb. 18, 2021.
(60) Provisional application No. 63/211,864, filed on Jun. 17, 2021.
(60) Provisional application No. 63/273,026, filed on Oct. 28, 2021.

(51) Int. Cl. H01M 4/38; H01M 4/587; H01M 10/0565; H01M 4/505; H01M 4/525

(52) U.S. Cl. CPC H01M 4/386; H01M 4/382; H01M 4/587; H01M 2004/021; H01M 4/505; H01M 4/525; H01M 10/0565

(57) ABSTRACT

A battery can include a lithium cathode, a silicon anode, a separator between the lithium cathode and the silicon anode, and an electrolyte. The silicon anode can include a silicon particle with an external volume expansion that is at most about 15% when the silicon particles are fully lithiated. A capacity of the silicon anode can be between about 1.05 and 1.5 times the capacity of the lithium cathode.

### CROSS-REFERENCE TO RELATED APPLICATIONS

This application claims the benefit of U.S. Provisional Application No. 63/150,880, filed 18 Feb. 2021, U.S. Provisional Application No. 63/211,864, filed 17 Jun. 2021, and U.S. Provisional Application No. 63/273,026, filed 28 Oct. 2021, each of which is incorporated in its entirety by this reference.

### TECHNICAL FIELD

This invention relates generally to the battery field, and more specifically to a new and useful system and method in the battery field.

### BRIEF DESCRIPTION OF THE FIGURES

FIG. 1 is a schematic representation of the system.

FIGS. 2A and 2B are schematic representations of exemplary battery systems.

FIGS. 3A, 3B, 3C, and 3D are schematic representations of exemplary battery systems.

FIG. 4 is a schematic representation of an exemplary silicon anode.

FIGS. 5A and 5B are schematic representations of exemplary silicon materials coated with an SEI layer.

FIG. 6 is a schematic representation of an exemplary silicon anode that includes lithiated and nonlithiated silicon.

FIG. 7 is a schematic representation of an exemplary battery that includes a plastic weld and a second weld.

FIGS. 8A and 8B are schematic representations of exemplary batteries that includes tabs.

FIG. 8C is a schematic representation of an exemplary tabless battery.

FIGS. 9A-9E are schematic representations of exemplary silicon particles.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

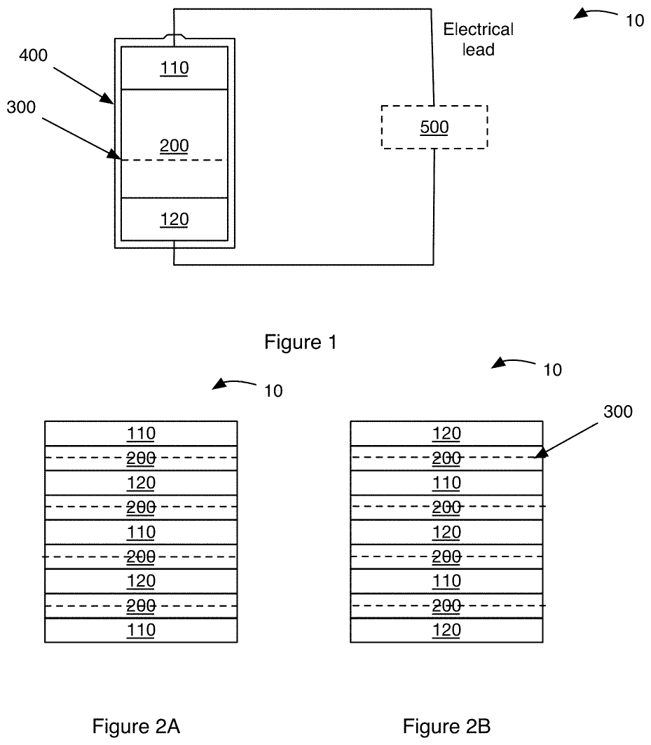

As shown in FIG. 1, the system 10 can include electrodes 100 (e.g., an anode 110, a cathode 120) and an electrolyte 200. The system can optionally include a separator 300, a connector, a housing 400, and/or any suitable components.

The battery system 10 preferably functions to generate or produce electrical power and/or provide or supply the electrical power to one or more loads 500 (e.g., which can function to consume the electrical power such as to convert it into another form of energy). The electrical power is typically derived from an electrochemical potential that exists between two electrodes. The electrical power is preferably provided by one or more connectors. Examples of connectors include inductive coils (e.g., to facilitate wireless electrical transfer), wires, metal pads, frames, balls, pins, and/or any suitable connector. The load can be a resistive load, a capacitive load, an inductive load, and/or any suitable load(s). In some examples, particularly but not exclusively when the system is flexible, the battery system (and/or load) can be integrated into IoT devices, medical devices, electrical vehicles (e.g., electric cars, electric bicycles, electric scooters, electric trucks, electric planes, etc.), and/or any suitable application(s).

### 2. Benefits.

Variations of the technology can confer several benefits and/or advantages.

First, variants of the technology can enable batteries that include silicon material to undergo a large number (e.g., >10, >50, >100, >500, >1000, >5000, >10000, >50000, >100000, etc.) of cycles without significant degradation (e.g., <0.1%, 0.1%, 0.5%, 1%, 2%, 5%, 10%, 15%, 20%, 25%, 30%, values or ranges therebetween, etc. change in battery capacity, open circuit voltage, state of charge, etc. after a number of charge and discharge cycles have been performed). Examples of the technology can enable the large number of cycles by forming a stable SEI layer on the silicon material and/or using a silicon material with a small external expansion volume such that the SEI layer remains intact (e.g., does not crack) during expansion of the silicon material.

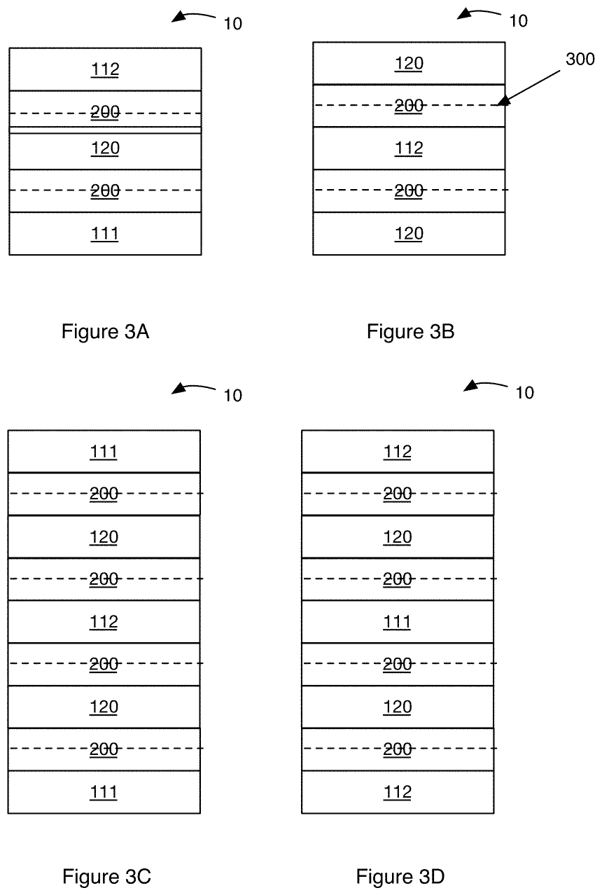

Second variants of the technology can enable high energy density and fast recharging batteries. In a specific example, as shown in FIG. 3A, the battery system can include a silicon-based anode (e.g., to facilitate a high energy density) and a lithium metal anode (e.g., to facilitate fast charging).

However, variants of the technology can confer any other suitable benefits and/or advantages.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30%, etc. of a reference), or be otherwise interpreted.

### 3. System.

As shown in FIG. 1, the system 10 can include electrodes 100 (e.g., an anode 110, a cathode 120) and an electrolyte 200. The system can optionally include a separator 300, a housing 400, a connector, and/or any suitable components. The battery system 10 preferably functions to generate or produce electrical power and/or provide or supply the electrical power to one or more loads (e.g., which can function to consume the electrical power such as to convert it into another form of energy). The battery system is preferably a secondary cell (e.g., a rechargeable battery system such as one where each electrode can operate as an anode or cathode), but can additionally or alternatively form primary cells, bipolar cells, and/or any suitable battery cell. The battery system is preferably operated (e.g., cycled) between about 2.5V and 5V (and/or a range contained therein such as 2.5-4.2V, 2.7V-4.2V, 2.5-4V, 2.7-3.8V, 2.7-4.3V, etc.), but can be cycled between any suitable voltages (e.g., less than 2.5V or greater than 5V). In some variants, limiting the range of operation voltages can improve the stability and/or longevity (e.g., number of cycles before significant degradation occurs, number of cycles before critical battery failure, etc.) of the battery system. The voltage range that the battery system can be operated over can depend on the electrode materials, the electrode capacities, the electrode thicknesses, the load, a programmed (or otherwise specified) voltage range, and/or any suitable properties.

The components of the system can be solid-state, fluid-state (e.g., liquid, plasma, gas, etc.), gel-state, a combination of states (e.g., at a critical point, a mixed state, one component in a first state and another component in a second state, etc.), and/or have any suitable state of matter. The resultant battery can have a solid state build, Li metal build (e.g., lithium-ion or lithium polymer batteries), metal-air build (e.g., silicon-air battery), and/or any other suitable construction. The resultant battery can be rigid, flexible, and/or have any other suitable stiffness (e.g., wherein component thicknesses, numerosity, flexibility, rigidity, state of matter, elasticity, etc. can be selected to achieve the desired stiffness). The resultant battery can be a pouch cell, a cylindrical cell, a prismatic cell, and/or have any other suitable form factor.

The electrodes loo preferably function to generate ions (e.g., electrons) and to make contact to other parts of a circuit (e.g., a load). The battery system preferably includes at least two electrodes (e.g., an anode and a cathode), but can include any number of electrodes. The number of cathodes and anodes can be equal, there can be more anodes than cathodes, or there can be more cathodes than anodes. For example, the battery can include 1, 2, 3, 4, 5, 6, 10, 20, 50, 100, values or ranges therebetween, and/or any other suitable number of anodes and/or cathodes. The anodes and/or cathodes can be single-sided, double sided, and/or otherwise configured. When the battery includes multiple anodes and/or cathodes, the anodes and cathodes are preferably interleaved (e.g., alternate in the electrode stack); alternatively, the cathodes and/or anodes can be grouped or stacked together and/or can otherwise be arranged (e.g., a single cathode can be surrounded by a plurality of anodes dictated by a cell geometry). Each anode of the plurality of anodes can be the same (e.g., same materials, same physical properties within specification tolerances, same electrical properties, etc.) or different (e.g., different materials, different physical properties, different electrical properties, etc.). Each cathode of the plurality of cathodes can be the same (e.g., same materials, same physical properties within specification tolerances, same electrical properties, etc.) or different (e.g., different materials, different physical properties, different electrical properties, etc.). In a first illustrative example, as shown in FIG. 2A, the battery system can include a lithium metal anode opposing a lithium cathode across electrolyte and the lithium cathode can oppose a silicon anode across electrolyte (e.g., the same or different electrolyte can be used between each anode and cathode pair). In a second illustrative example as shown in FIG. 2B, a first lithium cathode can oppose a silicon anode across electrolyte and the silicon anode can oppose a second lithium cathode across electrolyte. However, the electrodes can otherwise be arranged.

Each electrode is preferably in contact with a collector, which functions to collect and transport electrons. The collector can be different or the same for each electrode. The collector is preferably electrically conductive, but can be semiconducting and/or have any suitable conductivity. The collector can be a wire, a plate, a foil, a mesh, a foam, an etched material, a coated material, and/or have any morphology. Example collector materials include: aluminium, copper, nickel, titanium, stainless steel, carbonaceous materials (e.g., carbon nanotubes, graphite, graphene, etc.), brass, polymers (e.g., conductive polymers such as PPy, PANi, polythiophene, etc.), combinations thereof, and/or any suitable material. The collector can be fastened to, adhered to, soldered to, integrated with (e.g., coextensive with a substrate of), and/or can otherwise be interfaced with the electrode.

Each electrode can be a layered material, a coextensive material (e.g., single or polycrystalline), thin films (e.g., 1 nm to 100 μm thick and/or any values or subranges therein), thick films (e.g., >100 μm thick), and/or have any suitable morphology. The number of layers can be determined based on a target specific energy, charge rate, discharge rate, cost, weight, capacity (e.g., specific capacity), thickness, battery temperature (e.g., ambient temperature proximal the load, expected operation temperature, local temperature of the battery, load temperature, etc.), cell variation, and/or other property of the electrode. For example, an electrode can include between 1 and 100 layers. However, an electrode can include more than 100 layers.

Each electrode thickness can be any suitable value or range thereof between about 1 μm and 1 cm (such as 1 μm, 2 μm, 5 μm, 10 μm, 20 μm, 50 μm, 100 μm, 200 μm, 500 μm, 1 mm, 2 mm, 5 mm, 1 cm), a thickness less than 1 μm, and/or a thickness greater than 1 cm. The thickness of each layer can be the same and/or different. For example, an anode can have a thickness approximately equal to 0.1×, 0.2×, 0.5×, 0.8×, 0.9×, 1×, 1.05×, 1.1×, 1.2×, 1.5×, 2×, 2.1×, 2.2×, 2.5×, 3×, 5×, 10×, or values therebetween of the cathode thickness. In a variation on this example, these ratios can relate the capacity of the anode to the cathode (e.g., an anode thickness can be determined to have a thickness that will match an anode capacity to a ratio of the cathode capacity such as in units of mAh/cm²). Having a thicker anode (e.g., thicker than necessary to match a cathode capacity) can be beneficial, for example, because as the cathode transfers material to the anode (e.g., during discharging), the anode may not expand by as much as if the anode and cathode had matching capacities. This benefit can be enabled, for instance, by using an anode material with a large capacity (such as silicon). However, a thicker anode can otherwise be beneficial and/or be enabled.

The N/P ratio (e.g., a capacity ratio such as a linear capacity, an areal capacity, volumetric capacity, total capacity, etc. of the anode to the cathode) is preferably between about 0.5-2 (e.g., 0.5, 0.6, 0.75, 0.9, 1, 1.05, 1.1, 1.15, 1.2, 1.25, 1.3, 1.35, 1.4, 1.45, 1.5, 1.6, 1.7, 1.75, 1.8, 1.9, 2, values or ranged therebetween, etc.), but can be less than 0.5 or greater than 2. A larger N/P ratio can be beneficial for increasing the stability of the anode (e.g., because the anode will be less lithiated and undergo less volume expansion compared to a battery with a smaller N/P ratio). The N/P ratio (e.g., an optimal N/P ratio) can be selected based on the anode material (or properties thereof such as particle or grain size, external expansion coefficient, etc.), cathode material (or properties thereof), battery stability (e.g., a target stability), battery cycles (e.g., a target number of cycles, minimum number of cycles, etc.), energy density, voltage range, electrode thickness, temperature, cell variation, number of layers, electrolyte composition, and/or can otherwise be selected or tuned.

In an illustrative example, for a cathode (e.g., an NMC, LCO, LMO, etc. cathode) with a capacity that is about 4.3 mAh/cm², the anode (e.g., silicon anode) can have a capacity that is about 8.6 mAh/cm² (e.g., 8.6±0.5 mAh/cm², 8.6±0.8 mAh/cm², etc.). In the first illustrative example, approximately half (e.g., between about 40-60%) of the anode can be lithiated (such as before discharging the cathode; which approximately halves the anode capacity). In a second illustrative example, for a cathode with a capacity that is about 4.3 mAh/cm2, the anode can have a capacity that is about 6.4±0.5 mAh/cm2. In the second illustrative example, approximately 20-30% of the anode can be lithiated. However, the anode and/or cathode can otherwise be matched. In variations of the first and/or second illustrative examples, the portion of the anode material that is not lithiated preferably has a capacity that matches the capacity of the cathode (e.g., to hinder or minimize plating of the anode with lithium). However, the cathode and/or anode can otherwise be matched (e.g., depending on the capacity of the anode material, anode formulation loading, etc.).

Each electrode can have a single active surface, two active surfaces (e.g., a top and a bottom surface), be active around all or any portion of the exposed surface, and/or have any suitable number of active surfaces, where active surfaces can refer to a surface coupled (e.g., via electrolyte) to another electrode, to an external load (e.g., via a collector), and/or otherwise be defined.

Each electrode preferably has approximately the same capacity (e.g., within ±1%, ±2%, ±5%, ±10%, ±20%, etc.). However, electrodes can have different capacities. For example, an anode can have a capacity approximately equal to 0.1×, 0.2×, 0.5×, 0.8×, 0.9×, 1×, 1.05×, 1.1×, 1.2×, 1.5×, 2×, 2.1×, 2.2×, 2.5×, 3×, 5×, 10×, and/or values therebetween of the cathode capacity (for example, in units of mAh/cm²). However, the anode can have a capacity less than 0.1× or greater than 10× the cathode capacity. Having anodes with capacities greater than the cathode can be beneficial for modifying (e.g., improving) a stability of the anode, modifying (e.g., controlling) an expansion of the anode, modifying (e.g., decreasing) an amount of anode plating from the cathode, and/or can otherwise be beneficial. Each electrode capacity can be controlled or modified based on an electrode thickness, an electrode material, an electrode doping, an electrolyte, an electrode doping, an electrode morphology (e.g., porosity, pore volume, pore distribution, etc.), an electrode substrate, and/or any suitable properties.

The electrode substrate 130 (e.g., collector) is preferably a metal (e.g., aluminium, copper, silver, gold, nickel, alloys thereof or incorporating the aforementioned elements, etc.), but can additionally or alternatively include carbonaceous substrates and/or any suitable substrate(s). The substrate thickness is preferably between about 5-20 μm. However, the substrate thickness can be greater than 20 μm or less than 5 μm. In an illustrative example, an anode substrate can be a 9-16 μm thick copper foil. In a second illustrative example, a cathode substrate can be a 9-20 μm thick aluminium foil. However, any substrate can be used.

The anode 110 functions, during discharging of the battery, to release electrons to an external circuit (e.g., to a load). The anode is preferably ionically coupled to the cathode by an electrolyte (where the anode is in physical contact with the electrolyte) and can be electrically coupled to the cathode by a load (e.g., via a connector, lead, during closed circuit operation, etc.), but can otherwise be electrically coupled to any suitable components. The anode can be cast, grown, deposited, molded, and/or otherwise manufactured.

The anode material is preferably porous, but can be solid, hollow, and/or have any suitable structure. The porous nature of the anode material preferably enables internal expansion within the anode material, but can otherwise function. Within the anode material, particles can cooperatively form pores (e.g., an open internal volume, void space, etc.) within a cluster (and/or a secondary particle can be formed from primary particles), pores can result from void space that remains after particle packing (e.g., imperfect packing efficiency, suboptimal packing efficiency, etc.), because of a characteristic size distribution of the particles (e.g., distribution shape, distribution size, etc.), from fusing particles together (e.g., to trap pores, open space, etc. inside of the fused particle), and/or can otherwise result. A porosity of the anode material is preferably between about 5% and 90%, but can be less than 5% or greater than 90%. The porosity can depend on the anode morphology (e.g., particle size, characteristic size, shape, etc.), anode material source, impurities in the anode material, and/or any suitable properties. A pore volume of the anode material is preferably between about 0.02 and 2 cm³g⁻¹, but can be less than 0.02 cm³g⁻¹ or greater than 2 cm³g⁻¹. The pore size of the anode material is preferably between about 0.5 and 200 nm, but the pore size can be smaller than 0.5 nm or greater than 200 nm. The pore size distribution (e.g., within a porous particle, cooperatively defined between pores, etc.) can have pore size (e.g., average size, mean size, etc.) between about 0.1 nm and about 5 μm, such as 0.2 nm, 0.5 nm, 1 nm, 2 nm, 5 nm, 10 nm, 20 nm, 25 nm, 30 nm, 40 nm, 50 nm, 75 nm, 100 nm, 150 nm, 200 nm, 300 nm, 400 nm, 500 nm, 750 nm, 1 μm, 1.5 μm, 2 μm, 3 μm, 4 μm, and/or 5 μm. However, the pore size can be less than 0.1 nm and/or greater than 5 μm. The pore size distribution can be monomodal or unimodal, bimodal, polymodal, and/or have any suitable number of modes. In specific examples, the pore size distribution can be represented by (e.g., approximated as) a gaussian distribution, a Lorentzian distribution, a Voigt distribution, a uniform distribution, a mollified uniform distribution, a triangle distribution, a Weibull distribution, power law distribution, log-normal distribution, log-hyperbolic distribution, skew log-Laplace distribution, asymmetric distribution, skewed distribution, and/or any suitable distribution.

The exterior surface of the anode material is preferably substantially sealed (e.g., hinders or prevents an external environment from penetrating the exterior surface). However, the exterior surface can be partially sealed (e.g., allows an external environment to penetrate the surface at a predetermined rate, allows one or more species from the external environment to penetrate the surface, etc.) and/or be open (e.g., porous, include through holes, etc.). The exterior surface can be defined by a thickness or depth of the anode material. The thickness is preferably between about 1 nm and 10 μm (such as 1 nm, 2 nm, 3 nm, 5 nm, 10 nm, 20 nm, 50 nm, 100 nm, 200 nm, 500 nm, 1 μm, 2 μm, 5 μm, 10 μm, values therebetween), but can be less than 1 nm or greater than 10 μm. The thickness can be homogeneous (e.g., approximately the same around the exterior surface) or inhomogeneous (e.g., differ around the exterior surface). In specific examples, the exterior surface can be welded, fused, melted (and resolidified), and/or have any morphology.

The surface area of the exterior surface of the anode and/or anode material (e.g., an exterior surface of the particles, an exterior surface of a cluster of particles, an exterior surface of an agglomer of particles and/or clusters, etc.) is preferably small (e.g., less than about 0.01, 0.5 m²/g, 1 m²/g, 2 m²/g, 3 m²/g, 5 m²/g, 10 m²/g, 15 m²/g, 20 m²/g, 25 m²/g, 30 m²/g, 50 m²/g, values or between a range thereof), but can be large (e.g., greater than 50 m²/g, 75 m²/g, 100 m²/g, 110 m²/g, 125 m²/g, 150 m²/g, 175 m²/g, 200 m²/g, 300 m²/g, 400 m²/g, 500 m²/g, 750 m²/g, 1000 m²/g, 1250 m²/g, 1400 m²/g, ranges or values therebetween, >1400 m²/g) and/or any suitable value.

The surface area of the interior of the anode material (e.g., a surface exposed to an internal environment that is separated from with an external environment by the exterior surface, a surface exposed to an internal environment that is in fluid communication with an external environment across the exterior surface, interior surface, etc. such as within a particle, cooperatively defined between particles, between clusters of particles, between agglomers, etc.) is preferably large (e.g., greater than 10 m²/g, 15 m²/g, 20 m²/g, 25 m²/g, 30 m²/g, 50 m²/g, 75 m²/g, 100 m²/g, 110 m²/g, 125 m²/g, 150 m²/g, 175 m²/g, 200 m²/g, 300 m²/g, 400 m²/g, 500 m²/g, 750 m²/g, 1000 m²/g, 1250 m²/g, 1400 m²/g, ranges or values therebetween, >1400 m²/g), but can be small (e.g., less than about 0.01, 0.5 m²/g, 1 m²/g, 2 m²/g, 3 m²/g, 5 m²/g, 10 m²/g, values or between a range thereof). However, the surface area of the interior can be above or below the values above, and/or be any suitable value.

In some variants, the surface area can refer to a Brunner-Emmett-Teller (BET) surface area. However, any definition, theory, and/or measurement of surface area can be used.

The anode material preferably undergoes an external expansion (e.g., external linear expansion, external volumetric expansion, etc.) that is at most 40% (e.g., at most 0%, 0.1%, 0.5%, 1%, 2%, 5%, 10%, 15%, 20%, 25%, 30%, −40%, −30%, −25%, −20%, −15%, −10%, −5%, −2%, −1%, −0.5%, −0.1%, etc., or within a range defined therein), with any other expansion being internal expansion (e.g., internal volumetric expansion). However, the anode material can undergo greater than 40% external expansion. Examples of expansion sources include: thermal expansion, swelling (e.g., expansion due to absorption of solvent or electrolyte), atomic or ionic displacement, atomic or ionic intercalation (e.g., metalation, lithiation, sodiation, potassiation, etc.), electrostatic effects (e.g., electrostatic repulsion, electrostatic attraction, etc.), and/or any suitable expansion source.

The anode material can include particles 114 (e.g., nanoparticles, mesoparticles, microparticles, macroparticles, etc.), films, and/or any suitable components and/or morphologies. A characteristic size of the anode material is preferably between about 1 nm to about 10000 nm such as 2 nm, 5 nm, 10 nm, 20 nm, 25 nm, 30 nm, 50 nm, 75 nm, 100 nm, 125 nm, 150 nm, 175 nm, 200 nm, 250 nm, 300 nm, 400 nm, 500 nm, 1000 nm, 1500 nm, 2000 nm, 5000 nm, values or ranges therebetween, and/or other sizes. However, the characteristic size can additionally or alternatively be less than about 1 nm and/or greater than about 10000 nm. In specific examples, the characteristic size can include the radius, diameter, circumference, longest dimension, shortest dimension, length, width, height, pore size, a shell thickness, film thickness, and/or any size or dimension of the particle. The characteristic size of the particles is preferably distributed on a size distribution. The size distribution can be a substantially uniform distribution (e.g., a box distribution, a mollified uniform distribution, etc. such that the number of particles or the number density of particles with a given characteristic size is approximately constant), a Weibull distribution, a normal distribution, a log-normal distribution, a Lorentzian distribution, a Voigt distribution, a log-hyperbolic distribution, a triangular distribution, a log-Laplace distribution, and/or any suitable distribution.

The particle size distribution is preferably narrow (e.g., full width half max (FWHM) less than about 1 nm, 5 nm, 10 nm, 20 nm, 50 nm, 100 nm, 500 nm, 1 μm, 5 μm, values therebetween, etc.; standard deviation that is less than about 1 nm, 5 nm, 10 nm, 20 nm, 50 nm, 100 nm, 500 nm, 1 μm, 5 μm, values therebetween, etc.; size parameter such as standard deviation that is less than a mean of the distribution; size parameter such as standard deviation, variance, higher-order moments of the distribution, skew, kurtosis, etc. that is at most 0.1%, 0.5%, 1%, 2%, 5%, 10%, 20%, etc. of a mean, lower order moments, mode, median, etc.; etc.), but can be broad and/or have any suitable size distribution.

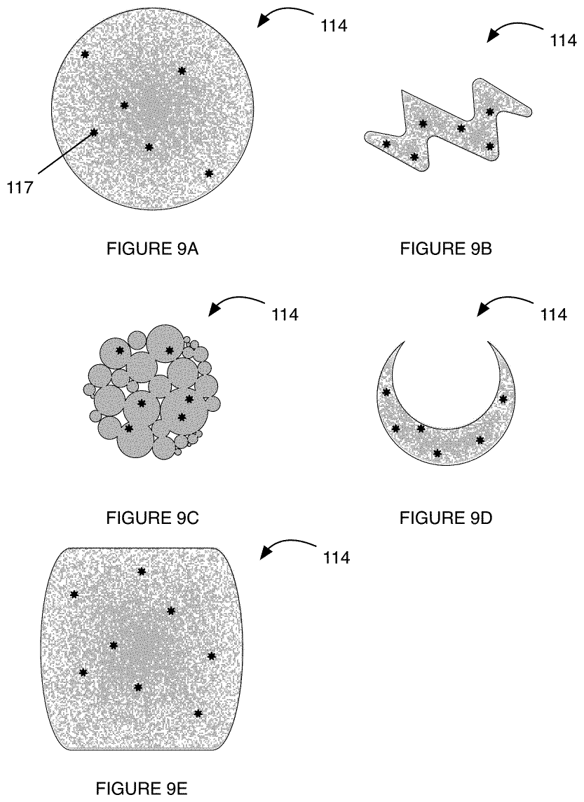

The shape of the particles can be spheroidal (e.g., spherical, ellipsoidal, as shown for example in FIG. 9A or 9C, etc.); rod; platelet; star; pillar; bar; chain; flower; reef; whisker; fiber; box; polyhedron (e.g., cube, rectangular prism, triangular prism, as shown for example in FIG. 9E, etc.); have a worm-like morphology (as shown for example in FIG. 9B, vermiform, etc.); have a foam like morphology; have an egg-shell morphology; have a shard-like morphology (e.g., as shown for example in FIG. 9D); and/or have any suitable morphology.

The particles can be freestanding, clustered, aggregated, agglomerated, interconnected (e.g., fused, welded, etc.), and/or have any suitable relation or connection(s). For example, the particles (e.g., primary structures) can cooperatively form secondary structures (e.g., clusters) which can cooperatively form tertiary structures (e.g., agglomers). A characteristic size (e.g., radius, diameter, smallest dimension, largest dimension, circumference, longitudinal extent, lateral extent, height, etc.) of the primary structures can be between about 2-150 nm. A characteristic size of the secondary structures can be 100 nm-10 μm. A characteristic size of the tertiary structures can be between about 1 μm and 100 μm. In an illustrative example, secondary particles (e.g., with a size between about 1-10 micrometers) can include primary particles (e.g., with a size between about 10 nm and 1 μm, 10 nm to 100 nm, etc.) that are fused together (e.g., as a result of milling the primary particles). In a variation of this illustrative example, the secondary particles can agglomerate to form agglomers (e.g., tertiary particles). However, the primary, secondary, and/or tertiary structures can have any suitable extent.

The anode preferably includes silicon material 112 (e.g., a silicon material disclosed in U.S. patent application Ser. No. 17/097,814 titled ‘POROUS SILICON MANUFACTURED FROM FUMED SILICA’ filed 13 Nov. 2020, U.S. patent application Ser. No. 17/525,769 titled ‘SILICON MATERIAL AND METHOD OF MANUFACTURE’ filed 12 Nov. 2021, and/or U.S. Provisional Application 63/192,688 titled ‘SILICON MATERIAL AND METHOD OF MANUFACTURE’ filed 25 May 2021, each of which is incorporated in its entirety by this reference). However, the anode can additionally or alternatively include: graphite powder (e.g., artificial graphite, natural graphite), lithium titanium oxide, activated carbon, carbonaceous materials (e.g., nanostructured carbonaceous materials), metal oxides, metal nitrides, metal sulfides, metal phosphides, silicon, germanium, tin, phosphorous, antimony, indium, lithium metal 111, and/or any suitable anode materials. The anode is preferably at least about 50% silicon (e.g., by weight, by volume, by stoichiometry, etc.), but can be less than 50% silicon.

The anode material can include one or more dopants 117. The dopant(s) are preferably crystallogens (also referred to as a Group 14 elements, adamantogens, Group IV elements, etc. such as carbon, germanium, tin, lead, etc.). However, the dopant(s) can additionally or alternatively include: chalcogens (e.g., oxygen, sulfur, selenium, tellurium, etc.), pnictogens (e.g., nitrogen, phosphorous, arsenic, antimony, bismuth, etc.), Group 13 elements (also referred to as Group III elements such as boron, aluminium, gallium, indium, thallium, etc.), halogens (e.g., fluorine, chlorine, bromine, iodine, etc.), alkali metals (e.g., lithium, sodium, potassium, rubidium, caesium, etc.), alkaline earth metals, transition metals, lanthanides, actinides, and/or any suitable materials. The dopant concentration (e.g., mass concentration, purity concentration, atomic concentration, stoichiometric concentration, volumetric concentration, etc.) is preferably at most about 45% (e.g., 45%, 40%, 30%, 25%, 20%, 15%, 10%, 5%, 2%, 1%, 0.5%, 0.1%, 2-10%, 5-15%, 8-12%, 15-25%, 10-30%, values or ranges therebetween, etc.), but can be greater than 45% of the anode material composition (e.g., particle composition).

The anode is preferably loaded with between 0.1 mg/cm² and 50 mg/cm² of anode material, but can be loaded with less than 0.1 mg/cm², greater than 50 mg/cm², and/or any suitable amount of anode material. The amount of anode material can depend on a target capacity, a target output power, a target energy density, an anode material, a load, a load application, a charging/discharging rate, a battery temperature, cell variation, cycle life, and/or be otherwise determined.

The anode material can be coated or uncoated. The coating(s) 118 can function to modify (e.g., increase, decrease) an electrical conductivity of the anode, modify (e.g., increase, decrease) an electrical conductivity path length (e.g., relative to the native anode material) of the anode, modify a physical property (e.g., elasticity, mechanical resilience, young's modulus, etc.) of the anode, modify a chemical property (e.g., reactivated to target species) of the anode, inhibit (or promote) formation of an interfacial layer on the anode, and/or otherwise function. The coating can be uniform or nonuniform. The coating can coat an interior surface (e.g., a pore volume) of the anode material, an exterior surface, portions thereof, and/or any suitable extent of the anode material. The coating is preferably elastic, but can be rigid, brittle and/or have any suitable mechanical properties. The coating is preferably electrically insulating, but can be semi-conducting or electrically conductive. The coating is preferably ionically conductive (e.g., allows or enables ions such as hydrogren, lithium, or other active ions to pass through), but can be ionically insulating, include an ionic pumping structure, and/or have any suitable ionic conductivity. In a specific example, the anode material can be a coated material (and/or can be coated) as disclosed in Ser. No. 17/667,361 titled “SILICON MATERIAL AND METHOD OF MANUFACTURE” filed on 8 Feb. 2022 which is incorporated in its entirety by this reference.

For example, an anode derived from silicon can be coated with carbonaceous material (e.g., organic molecules, polymers, inorganic carbon, nanocarbon, amorphous carbon, etc.), inorganic materials, plasticizers, biopolymeric membranes, ionic dopants, and/or any suitable materials. Examples of polymeric coatings include: polyacrylonitrile (PAN), polypyrrole (PPy), unsaturated rubber (e.g., polybutadiene, chloroprene rubber, butyl rubber such as a copolymer of isobutene and isoprene (IIR), styrene-butadiene rubber such as a copolymer of styrene and butadiene (SBR), nitrile rubber such as a copolymer of butadiene and acrylonitrile, (NBR), etc.), saturated rubber (e.g., ethylene propylene rubber (EPM), a copolymer of ethene and propene; ethylene propylene diene rubber (EPDM); epichlorohydrin rubber (ECO); polyacrylic rubber such as alkyl acrylate copolymer (ACM), acrylonitrile butadiene rubber (ABR), etc.; silicone rubber such as silicone (SI), polymethyl silicone (Q), vinyl methyl silicone (VMQ), etc.; fluorosilicone rubber (FVMQ); etc.), and/or any suitable polymer(s).

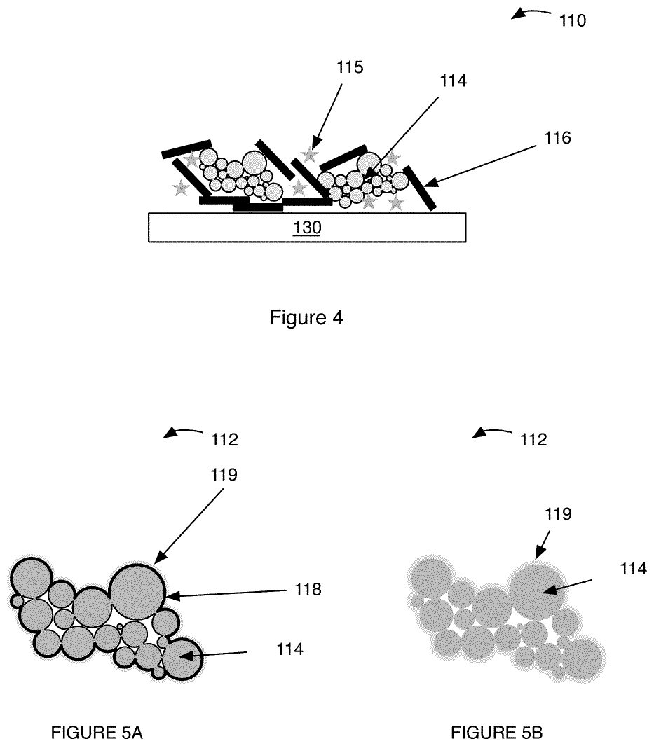

In a specific example, as shown in FIG. 4, an anode can include a silicon material, binder (which can function to bind the coating to the silicon material, to adhere the silicon material to a substrate, etc.), and conductive material disposed on a substrate (e.g., a collector).

In an illustrative example, the silicon material can have a structure that is substantially the same as that described for a silicon material disclosed in U.S. patent application Ser. No. 17/097,814 titled ‘POROUS SILICON MANUFACTURED FROM FUMED SILICA’ filed 13 Nov. 2020, U.S. patent application Ser. No. 17/525,769 titled ‘SILICON MATERIAL AND METHOD OF MANUFACTURE’ filed 12 Nov. 2021, and/or U.S. Provisional Application 63/192,688 titled ‘SILICON MATERIAL AND METHOD OF MANUFACTURE’ filed 25 May 2021, each of which is incorporated in its entirety by this reference. However, the silicon material can have any suitable structure.

In a second illustrative example, the silicon material can be or include porous carbon infused silicon, porous carbon decorated silicon structure, porous silicon carbon hybrid, a porous silicon carbon alloy, a porous silicon carbon composite, silicon carbon alloy, silicon carbon composite, carbon decorated silicon structure, carbon infused silicon, carborundum, silicon carbide, and/or any suitable allotrope or mixture of silicon, carbon, and/or oxygen. For instance, the elemental composition of the silicon material can include SiOC, SiC, SiₓOₓC, SiₓOₓC_{y}, SiOₓC_{y}, SiₓC_{y}, SiOₓ, SiₓO_{y}, SiO₂C, SiO₂Cₓ, SiOCZ, SiCZ, SiₓO_{y}CZ, SiₓOₓCₓZₓ, SiₓCₓZ_{y}, SiOₓZₓ, SiₓOₓZ_{y}, SiO₂CZ, SiO₂CₓZ_{y}, and/or have any suitable composition (e.g., include additional element(s)), where Z can refer to any suitable element of the periodic table and x and/or y can be the same or different and can each be between about 0.001 and 2 (e.g., 0.001, 0.005, 0.01, 0.05, 0.1, 0.5, 1, 2, 0.001-0.05, 0.01-0.5, 0.01-0.1, 0.001-0.01, 0.005-0.1, 0.5-1, 1-2, values or ranges therebetween etc.), less than 0.001, or greater than 2.

In a third illustrative example, the anode material can include a high-purity silicon material (e.g., a silicon material with at least 90% Si purity such as 95%, 97%, 98%, 99%, 99.5%, 99.9%, 99.99%, 99.995%, 99.999%, values therebetween, etc.; silicon material with at most about 1%, 0.5%, 0.1%, 0.05%, 0.01%, 0.005%, 0.001%, etc. of aluminium, calcium, iron, titanium, oxygen, carbon, and/or other impurities or inclusions). In a variation of the third specific example, the silicon material can include sub-loo nm silicon particles. In a second variation of the third specific example, the silicon material can include 100 nm to 100 μm silicon particles (e.g., 0.3 μm nanoparticles, 2-5 μm particles, 1-5 μm particles, 0-5 μm particles, 0-10 μm particles, 0-20 μm particles, ranges that can be contained therein, etc.; that can be manufactured by milling, co-welding, fusing, annealing, etc. smaller silicon particles such as 10 nm to 1 μm particles).

In a fourth specific example, the anode material can include silicon particles with a narrow size distribution (such as 3 μm particles with a size distribution that is ±100 nm, ±200 nm, ±500 nm, ±1 μm, etc.; 3.5 μm particles with a size distribution that is ±100 nm, ±200 nm, ±500 nm, ±750 nm, ±1 μm, etc.; 5 μm particles with a size distribution that is ±100 nm, ±500 nm, ±1 μm, ±2 μm, ±3 μm, etc.; 10 μm particles with a size distribution that is ±100 nm, ±500 nm, ±1 μm, ±3 μm, ±5 μm, ±7.5 μm, etc.; particles with a variance or deviation of ±0.1%, ±0.5%, ±1%, ±2%, ±3%, ±4%, ±5%, ±10%, 20%, values or ranges therebetween, <0.1%, etc. relative to a mean or other characteristic size of the particles; etc.). However, the silicon particles can have a large size distribution (e.g., where the distribution can become smaller during operation or use of the material as smaller particles aggregate, cluster, agglomerate, degrade, etc. during use) and/or any suitable size distribution.

In a fifth specific example of an anode material, the anode material can have a composition that is approximately 75% (e.g., 70-80%) silicon (e.g., silicon particles), approximately 10% (e.g., 5-15%) conductive material (e.g., graphitic carbon, electrically conductive carbon, carbon black, super-p carbon black, carbon super P, etc.), and approximately 15% (e.g., 10-20%) binder (e.g., PAA, CMC/SBR, etc.). The percentages can refer to mass percentages, volume percentages, composition percentages, and/or to any suitable percentages. In a variation of the fifth specific example, the anode material can include a composition that is about 75% silicon, 10-15% carbonaceous material (e.g., graphitic carbon), 2.5-5% polymer (e.g., PAN, PAA, CMC/SBR, etc.), and 2.5-5% conductive additive (e.g., C65 carbon black, conductive carbon, etc.).

In a sixth specific example of an anode material, the anode material can have a composition that is approximately 90% (e.g., 80-95%) silicon (e.g., silicon particles) and approximately 10% (e.g., 5-20%) PAN (e.g., which can act as a conductive material, binder, etc.). The percentages can refer to mass percentages, volume percentages, composition percentages, and/or to any suitable percentages.

In a seventh specific example of an anode material, the anode material can have a composition that is approximately 5%-15% carbon, 1%-10% oxygen, and 75%-94% silicon (potentially including traces of other elemental species). The percentages can refer to mass percentages, volume percentages, composition percentages (e.g., elemental analysis of the anode material), and/or to any suitable percentages. In the seventh specific example, the composition of carbon can include: dopants (e.g., within the silicon), coatings, binders, alloyed silicon with carbon, composites of silicon and carbon, and/or any suitable materials. In variations of the seventh specific example, at least 90% of the carbon composition is preferably graphitic carbon (which can be beneficial as it can contribute to the capacity of the anode). However, less than 90% of the carbon composition can be graphitic carbon (e.g., other electrically conductive carbon can be used, addition binder can be present, etc.).

In some variants, combinations of the preceding specific examples can be combined. For instance, a first anode layer can include a first type of anode and a second anode layer can include a second type of anode material. Similarly, an anode can include a mixture of anode materials. Additionally, or alternatively, an anode can be described by two or more of the specific examples simultaneously. However, the specific examples can otherwise be combined (and/or used in conjunction or isolation).

In variants, anode and/or material thereof can be metalated (e.g., lithiated) such as preloaded with cathode material. This can be beneficial to decrease (e.g., prevent, minimize, slow, hinder, etc.) plating (e.g., of the anode, container walls, etc.) with cathode material during battery operation and/or cycles (e.g., charging and/or discharging cycles), decrease (e.g., minimize, prevent, hinder, etc.) the loss of material from the cathode, can act as a reservoir for cathode material (e.g., to supply additional cathode material to the cathode during operation such as to replenish depleted cathode material), can form (e.g., pre-form) an SEI layer, and/or otherwise be beneficial. The anode material can be fully metalated (e.g., loaded with the greatest stoichiometric amount possible) and/or partially metalated (e.g., loaded with a predetermined amount of cathode material, loaded with a target amount of cathode material, a portion of the anode material loaded with cathode material and a second portion that does not include cathode material, etc.). The degree of metalation is preferably chosen such that the capacity of the nonmetalated anode material is the same as or greater than the capacity of the cathode; however, the nonmetalated anode material can have a capacity less than the cathode capacity. Additionally or alternatively, the degree of metalation can depend on an anode thickness, an anode expansion (e.g., expansion during metalation), an anode material, an anode capacity, a cathode thickness, a cathode capacity, a battery charging/discharging rate, a battery temperature, a load application, a load, cell variation, and/or any suitable anode or cathode property(ies). For example, any range of the anode between about 10%-100% can be metalated. However, less than 10% of the anode can be lithiated.

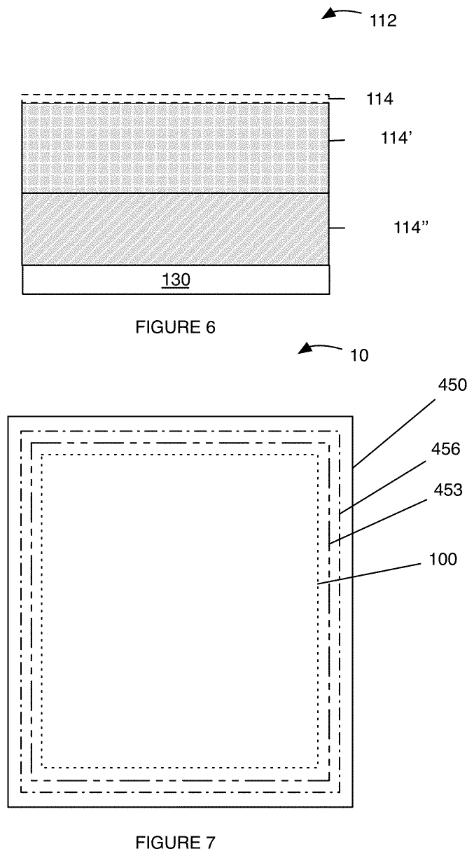

In an illustrative example as shown in FIG. 6, about 45% of the anode can be lithiated 114″ (e.g., prelithiated) and about 55% of the anode can be delithiated 114′ (e.g., have lithium removed after previously having been loaded with lithium, not be lithiated, etc.). In this illustrative example, the capacity of the delithiated portion of the anode can be approximately the same as (e.g., within about 10% of) the capacity of the cathode. In a variation of this illustrative example, the anode can include additional silicon material (e.g., silicon material that has not previously been lithiated) which can account for about 5-10% of the silicon anode (supplementing or replacing either or both of a delithiated and/or lithiated silicon material).

The anode material can be metalated, for example, by cycling (e.g., charging and/or discharging) an anode at a rate such as C/50, C/20, C/5, C/2, 1 C, and/or at any suitable rate. For example, the anode material can be cycled between 2.5-5V or any subset thereof (e.g., 2.5V-4.2V, 2.7V-4.2, 2.5-4V, 2.7-3.8V, 2.7-4.3V, etc.). However, the anode material can be cycled between any suitable voltages. In some variations, metalating the anode can include demetalating the anode (e.g., by discharging to a predetermined metalation level, for a predetermined time, etc.) such as to form a structure with a predetermined degree of metalation. The anode material is preferably metalated (and/or demetalated) before forming the battery stack, but can be metalated after forming the battery stack. The anode material can be metalated and demetalated at the same or different rates. In some variations, after metalation and/or demetallation, additional (e.g., pristine, virgin, etc.) anode material can be added to the anode stack (e.g., by deposition). The additional anode material is preferably added before forming the complete battery cell, but can be added during or after battery cell formation.

The anode (e.g., anode material) preferably does not include scaffold material (e.g., the anode material is preferably free-standing). However, the anode can optionally include scaffold material (e.g., where the anode material can be grown on, captured by, integrated in, etc. the scaffold material such as porous carbon, activated carbon, polymeric scaffolds, etc.).

The cathode 120 functions, during normal discharging of the battery system, to collect electrons from an external circuit (e.g., from a load). The cathode is preferably electrically coupled to the anode by an electrolyte (where the cathode is in physical contact with the electrolyte) and can be electrically coupled to a load (e.g., via a connector), but can otherwise be electrically coupled to any suitable components. The cathode material (e.g., an active ion of the cathode can be derived from) preferably includes lithium, but can additionally or alternatively include sodium, potassium, rubidium, caesium, beryllium, magnesium, calcium, strontium, barium, aluminium, zinc, and/or any suitable cathode materials. The cathode can be cast, grown, deposited, molded, and/or otherwise manufactured.

Examples of cathode materials include: lithium cobalt oxide (LCO), lithium nickel manganese cobalt oxide (NMC), lithium nickel manganese oxide (LNMO), lithium iron phosphate (LFP), lithium manganese oxide (LMO), lithium nickel cobalt aluminium oxide (NCA), and/or any suitable cathode materials.

The cathode is preferably loaded with between 0.1 mg/cm² and 50 mg/cm² of cathode material, but can be loaded with less than 0.1 mg/cm², greater than 50 mg/cm², and/or any suitable amount of cathode material. The amount of cathode material can depend on a target capacity, a target output power, a target energy density, a cathode material, and/or be otherwise determined.

The electrodes can optionally include one or more additives, where the additives can function to modify a chemical, electrical, mechanical, and/or other property of the electrode (and/or battery system). Examples of additives include binders, conductive materials, and/or other additives. The additives can be mixed with the electrode material, coat one or more surface (e.g., broad face) of an electrode or electrode material, and/or otherwise be integrated with or in contact with the electrode material. The additives are preferably elastic, but can be brittle, and/or have any suitable mechanical properties. The additives are preferably flexible, but can be rigid and/or have any suitable mechanical properties. The additives are preferably ionically conductive, but can be ionically insulating, promote (or hinder) ion diffusion, and/or have any suitable ionic conductivity. In some variants, additives (and/or coating materials) can swell (e.g., after absorbing electrolyte and/or solvent) which can modify their ionic conductivity. Between about 1 and 80% (e.g., by weight, by volume, etc.) of additives are preferably added to the electrode. However, less than 1% or greater than 80% additives can be included in the electrodes.

The binder 115 functions to secure (e.g., adhere) the electrode to the substrate and/or a case of the battery system. In some variants, the binder can function as a separator. For example, the binder can be cast on the anode and/or cathode (e.g., to a thickness between 1-50 μm). The binder is preferably electrically insulating, but can be electrically conductive, semiconducting, and/or have any suitable electrical conductivity. Examples of binders include: carboxymethyl cellulose (CMC), styrene-butadiene rubber (SBR), poly(acrylic acid) (PAA), sodium alginate (SA), polyvinylidene fluoride (PVDF), polyaniline (PANI), poly(9,9-dioctylfluorene-cofluorenone-co-methyl benzoic ester) (PFM), polytetrafluoroethylene (PTFE), poly(ethylene oxide) (PEO), polyvinyl alcohol (PVA), polyacrylonitrile (PAN), sodium carboxymethyl chitosan (CCTS), poly(3,4-ethylenedioxythiophene) polystyrene sulfonate (PEDOT:PSS), 3,4- propylenedioxythiophene (ProDOT), dopamine hydrochloride, polyrotaxanes, polythiophene, combinations thereof, and/or any suitable binder.

The conductive material 116 functions to modify an electrical conductivity of the electrode (e.g., to ensure that the electrode has at least a threshold electrical conductivity, to ensure that the electrode has at most a threshold electrical conductivity, etc.). Examples of conductive materials include: carbon super P, acetylene black, carbon black (e.g., C45, C65, etc.), mesocarbon microbeads (MCMB), graphene, carbon nanotubes (CNTs) (e.g., single walled carbon nanotubes, multiwalled carbon nanotubes, semi-conducting carbon nanotubes, metallic carbon nanotubes, etc.), reduced graphene oxide, graphite, fullerenes, conductive polymers, combinations thereof, and/or any suitable material(s).

Each electrode can be passivated by an interfacial layer (e.g., a solid electrolyte interface (SEI) layer 119). The interfacial layer is typically formed from the decomposition of electrolyte during the use of the battery system (e.g., charging and discharging), but can be formed before the battery system is assembled and/or otherwise be formed. The interfacial layer can surround (e.g., coat) a coating of the electrode material (e.g., as shown for example in FIG. 5A), can coat the electrode material (e.g., as shown for example in FIG. 5B), be integrated or intercalated into the electrode material or a coating thereof, can be coated (e.g., by a coating), and/or can otherwise be arranged.

The interfacial layer is preferably stable (e.g., remains substantially unchanged during charging and discharging after its formation), but can be unstable (e.g., degrade, and potentially reform, during one or more cycles) and/or have any suitable stability. For example, the interfacial layer can be an elastic or polymer-like compound (such as lithium alkyl carbonates, poly(ethylene oxides), etc.) such as an organic or organometallic compound, which can expand (without substantially breaking or cracking) or otherwise accommodate changes as the silicon anode expands and contracts. Examples of interfacial layer materials include: lithium ethyl carbonate (LEC), lithium methyl carbonate (LMC), lithium ethylene dicarbonate (LEDC), lithium propylene dicarbonate (LPDC), polymerized vinylene carbonate or poly(vinyl carbonate) (PVCA), carboxylic acid, lithium fluoride, lithium oxide, lithium silicate, lithium carbonate, combinations thereof, and/or other materials. However, the electrodes can be activated by the interfacial layer, can include no interfacial layer, and/or any suitable interfacial layer can be formed.

The electrolyte 200 preferably functions to electrically connect anode(s) to cathode(s) and enable or promote the movement of ions (but preferably not electrons) between the electrodes. However, the electrolyte can otherwise function. The electrolyte can be solid-phase, fluid phase (e.g., liquid-phase), and/or any suitable phase. For example, the electrolyte can be or include: a gel, a powder, a salt dissolved in a solvent, an acid, a base, a polymer, a ceramic, a salt (e.g., a molten salt), a plasma, ionic liquids, and/or have any suitable state or combination thereof of matter. The electrolyte can include organic materials, inorganic materials, and/or combinations thereof.

Examples of electrolytes (e.g., electrolyte salts), particularly but not exclusively for use with lithium ion batteries, include: lithium lanthanum titanates (e.g., Li_{0.34}La_{0.51}TiO_{2.94}, Li_{0.75}La_{0.5}TiO₃, (Li_{0.33}La_{0.56})_{1.005}Ti_{0.99}Al_{0.01}O₃, etc.), lithium aluminium phosphates (e.g., Li_{1.3}Al_{0.3}Ti_{1.7}(PO₄)₃, Li_{1.5}Al_{0.5}Ge_{1.5}(PO₄)₃, etc.), lithium zirconates (e.g., Li₇La₃Zr₂O₁₂, Li_{6.55}La₃Zr₂Ga_{0.15}O₁₂, Li_{6.4}La₃Zr₂Al_{0.2}O₁₂, etc.), lithium silicon phosphates (e.g., Li_{3.25}Si_{0.25}P_{0.75}O₄), lithium germanates (e.g., Li_{2.8}Zn_{0.6}GeO₄, Li_{3.6}Ge_{0.8}S_{0.2}O₄, etc.), lithium phosphorous oxynitrides (e.g., Li_{2.9}PO_{3.3}N_{0.46}), lithium phosphorous sulfides (e.g., Li₇P₃S₁₁, Li₁₀GeP₂S₁₂, Li_{3.25}Ge_{0.25}P_{0.75}S₄, Li_{3.4}Si_{0.4}P_{0.6}S₄, Li₃PS₄, etc.), lithium silicon phosphates (e.g., Li_{3.5}Si_{0.5}P_{0.5}O₄), lithium argyrodites (e.g., Li₆PS₅Br, LiPS₅Cl, Li₇PS₆, Li₆PS₅I, Li₆PO₅Cl, etc.), lithium nitrides (e.g., Li₃N, Li₇PN₄, LiSi₂N₃, etc.), lithium imide (e.g., Li₂NH), lithium borohydride (e.g., LiBH₄), lithium aluminium hydride (e.g., LiAlH₄), lithium amides (e.g., LiNH₂, Li₃(NH₂)₂I, etc.), lithium cadmium chloride (e.g., Li₂CdCl₄), lithium magnesium chloride (e.g., Li₂MgCl₄), lithium zinc iodide (e.g., Li₂ZnI₄), lithium cadmium iodide (e.g., Li₂CdI₄), lithium chlorate (e.g., LiClO₄), lithium bis(trifluoromethanesulfonyl)imide (e.g., LiC₂F₆NO₄S₂), lithium hexafluroarsenate (e.g., LiAsF₆), lithium hexaflurophosphate (e.g., LiPF₆), combinations thereof, and/or any suitable electrolytes (e.g., electrolyte salts, for instance replacing lithium with the appropriate ion associated with a cathode of the battery).

Examples of matrices (e.g., gels, hydrogels, polymers, solvents, etc.) can include: poly(ethylene oxide) (PEO), poly(vinylidene fluoride) (PVDF), polyacrylonitrile (PAN), poly(methyl methacrylate) (PMMA), ethylene carbonate (EC), diethyl carbonate (DEC), dimethyl carbonate (DMC), propylene carbonate (PC), polyethylene glycol (PEG), glycerol, water, combinations thereof, and/or any suitable matrix can be used. Typically, an electrolyte salt is dissolved in the matrix to a concentration between about 0.1 M and 10 M, but the concentration of the electrolyte salt can be less than 0.1M or greater than 10 M.

In some examples, a mixture of inorganic and organic electrolytes can be used such as: Li_{6.4}La₃Zr₂Al_{0.2}O₁₂ in PEO/LiTFSI, Li_{1.5}Al_{0.5}Ti_{1.5}(PO₄)₃ in PVDF/LiClO₄, or Li_{0.33}La_{0.557}TiO₃ in PAN/LiClO₄. However, any pure or combination of electrolytes can be used.

In some embodiments, the electrolyte can include one or more additives, which can function to facilitate (or hinder) the formation of the interfacial layer. Examples of additives include: vinylene carbonate (VC), fluoroethylene carbonate (FEC), propylene carbonate (and its derivatives), ammonium perfluorocaprylate (APC), vinyl ethylene carbonate (VEC), maleimides (e.g., ortho-phenylenedimaleimide, para-phenylenedimaleimide, meta-phenylenedimaleimide, etc.), glycolide, tetraoxaspiro[5,5]undecanes (TOS; such as 3,9-Divinyl-2,4,8,10-tetraoxaspiro[5,5]undecane), poly-ether modified siloxanes, combinations thereof, and/or other additives.

In a first illustrative example, an electrolyte can include: 1M LiPF₆ in a 1:1 v/v FEC/DMC solvent. In a second illustrative example, an electrolyte can include: 1M LiPF₆ in a 1:1 v/v EC/DEC solvent with 2% vol VC. In a third illustrative example, an electrolyte can include: 1M LiPF₆ in a 1:1 v/v EC/DMC. In a fourth illustrative example, an electrolyte can include: 1M LiPF₆ in a 1:1 v/v EC/DMC solvent with 3% vol VC. In a fifth illustrative example, an electrolyte can include: 1M LiPF₆ in a 1:1:1 v/v/v EC/DEC/DMC solvent with 5 wt % VC. In a sixth illustrative example, an electrolyte can include: 1M LiPF₆ in a 1:1 v/v DEC/FEC solvent. In a seventh illustrative example, an electrolyte can include: 1M LiPF₆ in a 1:1 v/v EC/DEC solvent. However, any suitable electrolyte can be used.

The optional separator 300 preferably functions to hinder, slow, or prevent an anode and cathode from electrically contacting one another (thereby shorting the battery) while allowing ions to pass through the separator. The separator is preferably flexible, but can be rigid and/or have any suitable mechanical property(s). The separator(s) are preferably ionically conductive, but can be ionically insulating, promote (or hinder) ion diffusion, and/or have any suitable ionic conductivity. The separator(s) can be permeable to electrolyte (e.g., be porous), can release electrolyte, can pump electrolyte, be solid, include through holes, be mesh, have unidirectional pathways, and/or can otherwise facilitate a (real, apparent, or effective) transfer of electrolyte from one side of the separator to the other. At least one separator is preferably arranged between each cathode/anode pair. However, the separator(s) can otherwise be arranged. The separator can be equidistant between the cathode and anode, closer to (e.g., proximal) the anode, or closer to (e.g., proximal) the cathode. However, the separator can otherwise be arranged. The separator preferably has a thickness between about 10 μm and 50 μm, but can be thinner than wpm or thicker than 50 μm.

The separator can be made of or include ceramics, gels, polymers, plastics, glass, wood, and/or any suitable materials. In some variants, a separator referred to as a “dry cell separator” can be used. Examples of separator materials include: polyolefin, polypropylene, polyethylene, combinations thereof (e.g., a mixture or blend of PP and PE), and/or any suitable separator material(s). In some variants, the separator can be a multi-layered separator. For instance, a polypropylene/polyethylene/polypropylene separator or a ceramic coated separator (e.g., ceramic coated PP, ceramic coated PE, ceramic coated PP/PE mixture, etc.) can be used. However, any suitable separator can be used.

In some variants, an ionic conductive polymer can be used as the separator and/or as an ionic conductive pathway (e.g., as electrolyte, as conductive material, etc.). The ionic conductive polymer can be mixed in and/or coat the anode and/or cathode and form an ionic conductive network throughout the cell. However, the ionic conductive polymer can otherwise be arranged.

In some variants, the separator and electrolyte can be the same and/or integrated together. For example, the separator and/or the electrolyte can include a lithium ion conductive glass or ceramic material such as: lithium lanthanum titanate (LLTO; e.g., Li₃ₓLa_{2/3-x}TiO₃ for 0<x<2/3 such as x=0.11), lithium lanthanum zirconate (LLZO; e.g., Li₇La₃Zr₂O₁₂), lithium lanthanum zirconium tantalate (LLZTO; e.g., Li_{6.75}La₃Zr_{1.75}Ta_{0.25}O₁₂), lithium aluminium germanium phosphate (LAGP; e.g., Li_{1.5}Al_{0.5}Ge_{1.5}P₃O₁₂), lithium aluminium silicon phosphorous titanium oxide (LASPT; e.g., Li₂Al₂SiP₂TiO₁₃), combinations thereof, and/or any suitable materials. However, any suitable lithium ion conductive glass or ceramic material can be used.

Variants of the battery system can be flexible (for example by controlling a number of electrode layers, by using flexible components such as flexible separators, etc.), semiflexible, rigid, and/or have any suitable mechanical properties.

In some embodiments, the battery can optionally include a coagulant or gelling agent which functions to solidify (e.g., dry, gel, etc.) one or more components of the battery, which can provide the benefit of slowing or decreasing the chance for the battery to start a fire. The coagulant can solidify in response to shock (e.g., a threshold force, a threshold pressure, etc.), temperature (e.g., a threshold temperature), humidity (e.g., a threshold water content), exposure to the environment (e.g., a threshold oxygen content, a threshold a threshold nitrogen content, a threshold organic content, in the presence of a predetermined species, etc.), and/or responsive to any stimulus. The coagulant can be: mixed with the electrolyte (e.g., as an additive), integrated into an electrode (the anode, the cathode), integrated into a body of the battery housing, contained in a separate compartment of the battery, and/or otherwise be arranged. Examples of coagulants can include organic coagulants (e.g., polyamines, polyDADMACs, melamine formaldehyde, tannins, etc.), inorganic coagulants (e.g., aluminium sulfate, aluminium chloride, polyaluminium chloride, aluminium chlorohydrate, ferric sulfate, ferrous sulfate, ferric chloride, silica, etc.), polymeric gel coagulants (e.g., poly (acrylonitrile-co-methacrylate) (P(AN-co-MA)), polyethylene glycol (PEG), etc.), combinations thereof, and/or any suitable coagulant. However, additionally or alternatively, the battery can include a fire retardant additive (e.g., organic phosphate compounds such as triphenylphosphate, tributylphosphate, etc.; minerals such as aluminium hydroxide, magnesium hydroxide, etc; organohalogen compounds such as chlorendic acid, decabromodiphenyl ether, etc.; etc.), and/or any suitable battery additives.

The battery system preferably includes a housing 400 (e.g., container), which functions to enclose the electrodes, electrolyte, separator, and/or collector. The housing can function to prevent shorting of the electrodes resulting from contact with objects in the external environment. The housing can be made of metal (e.g., steel, stainless steel, etc.), ceramics, plastic, wood, glass, and/or any suitable materials. Examples of housing shapes include round (e.g., coin, button, cylindrical, etc.), not round, flat (e.g., layer built, pouch 450, etc.), prismatic (e.g., square, rectangular, etc.), and/or any suitable shape.

The housing preferably includes two terminals (e.g., one positive and one negative), but can include more than two terminals (e.g., two or more positive terminals, two or more negative terminals), a single terminal, and/or any number of terminals. The terminals can function to connect the battery electrodes to a load. Examples of terminals include coiled terminals, spring terminals, plate terminals, and/or any suitable terminals.

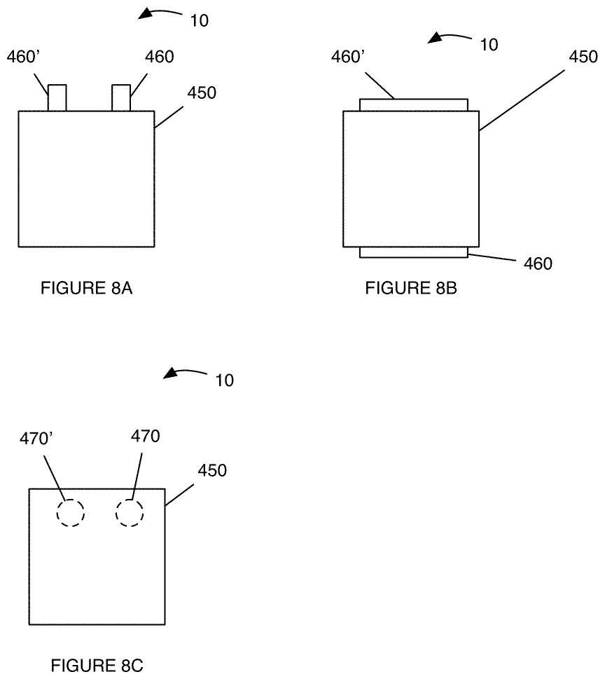

The housing can include end caps. The end caps can function as collectors and/or otherwise function. The end caps can be: tabbed end caps 460,460′ (e.g., as shown for example in FIG. 8A or FIG. 8B, which can extend out of a housing, can be flush with a housing, can extend by a target thickness from the housing, can extend along one or more edge of the housing, etc.), tabless end caps 470,470′ (e.g., as shown for example in FIG. 8C, such as having a hole or opening in the housing that enables access to an electrode collector, substrate, etc.), plate caps, and/or have any suitable morphology. The end caps can be made of: aluminium, copper, nickel, carbonaceous material, and/or any suitable conductive material (e.g., metals). The end caps (e.g., tabs, openings in the housing, etc.) can be symmetric (e.g., the same size, same shape, etc. for anode and/or cathode) and/or asymmetric (e.g., different size, different shape, etc. for anode and/or cathode). When tabs are used, the tabs can be arranged on a short side, a long side, and/or on any suitable side of the housing. As an illustrative example, a tab can extend about 2 mm from a surface (e.g., edge, body, etc.) of the housing (e.g., where a housing can have dimensions of approximately 40 mm, 100 mm, etc.) and can have an extent that is anywhere from 1% to 100% of a housing dimension (e.g., length, width, diagonal size, etc.). However, the housing can include any suitable caps or collectors in any suitable arrangement.

The housing can be sealed using adhesive, fastener(s), connector(s), binder(s), physical seal, chemical seals, electromagnetic seals, and/or any suitable connectors or sealing mechanism. The housing can include one, two, three, four, ten, values therebetween, and/or any suitable number of seals. In an illustrative example, as shown for instance in FIG. 7, a housing can be sealed using a first weld 453 (e.g., plastic ultrasonic weld, heat welder, speed tip welding, extrusion welding, contact welding, hot plate welding, non-contact welding, IR welding, high frequency welding, induction welding, injection welding, friction welding, spin welding, laser welding, etc.) followed by a second weld 456 (e.g., a metal weld, an ultrasonic metal weld, high temperature weld, arc weld, forge weld, oxy-fuel weld, friction weld, magnetic pulse weld, co-extrusion weld, cold weld, diffusion bonding, exothermic weld, high frequency weld, hot pressure weld, induction weld, roll bond, etc.). This illustrative example can provide a technical advantage of reducing a size (e.g., area, volume, weight, etc.) of the housing (e.g., pouch) by enabling a weld to be formed closer (e.g., decreasing an internal housing volume, decreasing an amount of electrolyte needed to load the housing, decreasing an amount of excess housing material, etc.) to the electrodes (e.g., with lower risk of damage to the electrodes). For instance, the plastic weld can be formed approximately 0.5 mm, 1 mm, 2 mm, 3 mm, 4 mm, 5 mm, 7.5 mm, 10 mm, values or ranges therebetween, >10 mm, from the electrodes. Although a small amount of excess space (e.g., distance between the weld and the electrodes) is preferable to ensure that the separator fully separates the electrodes, it may be possible to form the plastic weld over the edges of the electrodes (e.g., approximately 0 mm from the electrodes). After the plastic weld, a second weld (e.g., a metal weld) can be formed to help ensure the housing is (and remains) sealed. For example, an ultrasonic weld can be formed about 0.5 mm, 1 mm, 2 mm, 3 mm, 4 mm, 5 mm, 7.5 mm, 10 mm, values or ranges therebetween, >10 mm, from the plastic weld. The second weld is generally formed outside the plastic weld to increase a distance between the second weld and the electrodes (and thereby decreasing a chance of damaging an electrode during the welding process). For instance, the second weld can be 1 mm, 2 mm, 3 mm, 4 mm, 5 mm, 6 mm, 7 mm, 8 mm, 10 mm, and/or closer or further from the electrodes. However, the second weld can be coincident with, inside, and/or can otherwise be arranged relative to the first (e.g., plastic) weld. Additionally or alternatively, one or more of the welds can be replaced with and/or augmented with brazing, soldering, and/or any suitable fastening methods.

The battery can be assembled using conventional assembly methods, custom assembly methods, and/or other methods. For example, one or more electrode (or other component) can be printed, deposited, dried, cast (e.g., drop cast, spin cast, etc.), grown, and/or otherwise be generated or contacted. In an illustrative example, a silicon slurry can be printed on a substrate to form a silicon anode. However, the components can otherwise be manufactured.

In an illustrative example, as shown in FIG. 3A, a multielectrode battery can include: a silicon based anode, a lithium metal anode, and a cathode (e.g., NMC, LCO, etc.) arranged between the two anodes. In a variation of this specific example as shown in FIG. 3B, a silicon-based anode (e.g., double-sided anode) can be arranged between two cathodes (e.g., double-sided cathodes; LCO cathodes, NMC cathodes, etc.). In this variation, each cathode can be associated with a respective second anode (e.g., a lithium metal anode, a silicon anode, as shown for example in FIG. 3C). In this example and variation, the anodes and cathodes can be in electrical contact across an electrolyte, where the electrolyte can be solid phase or fluid phase. The electrolyte and separator between the silicon anode and the cathode can be the same or different from the electrolyte and/or separator between the lithium metal anode and the cathode. In specific examples, this construction can produce a hybrid cell lithium-metal cell or a solid state cell.

In a second variation of this specific example as shown in FIG. 3D, a lithium metal anode (e.g., double-sided anode) can be arranged between two cathodes (e.g., double-sided cathodes; LCO cathodes, NMC cathodes, etc.). In this variation, each cathode can be associated with a respective second anode (e.g., a silicon anode). In this variation, the anodes and cathodes can be in electrical contact across an electrolyte, where the electrolyte can be solid phase (e.g., gel, ceramic, etc.) or fluid phase. The electrolyte and separator between the silicon anode and the cathode can be the same or different from the electrolyte and/or separator between the lithium metal anode and the cathode. However, the electrodes can otherwise be arranged.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A battery comprising:
a lithium cathode;
a silicon anode comprising silicon particles with an external volume expansion that is at most about 15% when the silicon particles are fully lithiated;
a separator between the silicon anode and the lithium cathode; and
an electrolyte configured to conduct ions between the lithium cathode and the silicon anode.

2. The battery of claim 1, wherein the silicon particles comprise an internal surface area that is at least about 100 m²/g and an external surface area that is at most about 25 m²/g.

3. The battery of claim 2, wherein the silicon particles are coated with a carbonaceous material, wherein a surface area of the coated silicon particles is between about 1 and 20 m2/g.

4. The battery of claim 3, wherein the carbonaceous material comprises at least 90% graphite.

5. The battery of claim 3, wherein a coating thickness is between about 1 and 10 nm.

6. The battery of claim 1, wherein the silicon particles comprise a size between about 1-10 micrometers.

7. The battery of claim 7, wherein the silicon particles comprise primary particles with a size between about 2-100 nanometers that are fused together.

8. The battery of claim 1, wherein a composition of the silicon particles is about 2-10% carbon, about 1-5% oxygen, and about 85-97% silicon.

9. The battery of claim 1, wherein the electrolyte comprises at least one of:
LiPF₆ in an approximately 1:1 mixture of fluoroethylene carbonate and dimethyl carbonate;
LiPF₆ in an approximately 1:1:0.01 mixture of ethylene carbonate, diethyl carbonate, and vinylene carbonate;
LiPF₆ in an approximately 1:1 mixture of ethylene carbonate and dimethyl carbonate;
LiPF₆ in an approximately 1:1:0.015 mixture of ethylene carbonate, dimethyl carbonate, and vinylene carbonate;
LiPF₆ in an approximately 1:1:1:0.02 mixture of ethylene carbonate, diethyl carbonate, dimethyl carbonate, and vinylene carbonate;
LiPF₆ in an approximately 1:1 mixture of DEC and fluoroethylene carbonate; or
LiPF₆ in an approximately 1:1 mixture of ethylene carbonate and diethyl carbonate.

10. The battery of claim 1, wherein the lithium cathode comprises at least one of: lithium nickel manganese cobalt oxide, lithium nickel cobalt aluminium oxide, lithium manganese oxide, lithium iron phosphate, or lithium cobalt oxide.

11. A battery comprising:
a lithium cathode;
a silicon anode, wherein a capacity of the silicon anode is between about 1.05 and 1.5 times the capacity of the lithium cathode;
a separator between the silicon anode and the lithium cathode;
an electrolyte in contact with the lithium cathode and the silicon anode; and
an enclosure surrounding the silicon anode, the lithium cathode, and the separator.

12. The battery of claim 11, wherein the silicon anode comprises about 20% lithiated silicon and about 80% nonlithiated silicon.

13. The battery of claim 11, wherein the silicon anode comprises a silicon particle with an external surface area that is between about 5-20 m²/g, and an internal surface area that is greater than about 50 m²/g.

14. The battery of claim 13, wherein the silicon particle is manufactured from silica fumes.

15. The batter of claim 13, wherein the silicon particle comprises a carbonaceous coating, wherein the external surface area of the silicon particle without the carbonaceous coating is between about 10-30 m²/g.

16. The battery of claim 11, wherein a composition of the silicon anode is between about 70% and about 85% silicon and between about 15% and 30% carbon.

17. The battery of claim 11, wherein the electrolyte comprises at least one of a solid gel electrolyte, a polymeric electrolyte, or a ceramic electrolyte.

18. The battery of claim 11, wherein the enclosure comprises a pouch, wherein the pouch is sealed using a plastic weld and a metal weld, wherein the plastic weld is at most about 5 mm from the lithium cathode or the silicon anode.

19. The battery of claim 11, wherein a polymeric solid electrolyte interface layer forms on the silicon anode, wherein the polymeric solid electrolyte interface layer comprises lithium ethyl carbonate, lithium methyl carbonate, lithium ethylene dicarbonate, lithium propylene dicarbonate, or combinations thereof.

20. The battery of claim 11, wherein the lithium cathode comprises at least one of: lithium nickel manganese cobalt oxide, lithium nickel cobalt aluminium oxide, lithium manganese oxide, lithium iron phosphate, or lithium cobalt oxide.

21. The battery of claim 11, wherein the electrolyte comprises at least one of:
LiPF₆ in an approximately 1:1 mixture of fluoroethylene carbonate and dimethyl carbonate;
LiPF₆ in an approximately 1:1:0.01 mixture of ethylene carbonate, diethyl carbonate, and vinylene carbonate;
LiPF₆ in an approximately 1:1 mixture of ethylene carbonate and dimethyl carbonate;
LiPF₆ in an approximately 1:1:0.015 mixture of ethylene carbonate, dimethyl carbonate, and vinylene carbonate;
LiPF₆ in an approximately 1:1:1:0.02 mixture of ethylene carbonate, diethyl carbonate, dimethyl carbonate, and vinylene carbonate;
LiPF₆ in an approximately 1:1 mixture of DEC and fluoroethylene carbonate; or
LiPF₆ in an approximately 1:1 mixture of ethylene carbonate and diethyl carbonate.

22. The battery of claim 11, wherein a capacity of the battery decreases by at most 80% after 500 cycles.
